(19) United States
(12) Patent Application Publication
(10) Pub. No.: US 2014/0017034 A1
(43) Pub. Date: Jan. 16, 2014

(54) FASTENER DEVICE WITHOUT DRIVING TOOL

(71) Applicant: Feng Chih HO, Taipei (TW)

(72) Inventor: Feng Chih HO, Taipei (TW)

(21) Appl. No.: 13/548,278

(22) Filed: Jul. 13, 2012

(51) Int. Cl. F16B 35/00

(52) U.S. Cl. 411/402

(57) ABSTRACT

A fastener device includes a fastener member having a threaded shank, and a head formed on the threaded shank, and an actuating member includes a screw hole formed in a stem for engaging with the threaded shank of the fastener member, and includes a chamber communicative with the screw hole for engaging with the head of the shank and for allowing the fastener member to be selectively rotated by the actuating member, and for allowing the actuating member to be selectively rotated relative to the fastener member. The actuating member includes a housing formed on the stem. A sealing ring is engaged onto the shank for selectively engaging with the head of the shank of the fastener member.

### BACKGROUND OF THE INVENTION

1. Field of the Invention

The present invention relates to a fastener device, and more particularly to a fastener device including a structure or mechanism to be easily and quickly and readily driven and rotated or engaged or secured onto the workpiece by the users themselves without additional rotating or driving or actuating tools.

2. Description of the Prior Art

Typical fasteners comprise a threaded bolt or screw member to be driven and rotated or engaged or secured onto the workpieces with wrenches, screw drivers, or other driving tools for attaching or mounting or securing or coupling the workpieces together, or for attaching or mounting or securing or coupling the workpieces to the other supporting members.

For example, U.S. Pat. No. 6,530,299 to Liu, and U.S. Pat. No. 6,698,319 to Huang disclose two of the typical tool adapters or tool driving devices each comprising a tool retaining member for attaching or mounting or securing or holding the bolts or screws or fastener devices and for driving the bolts or screws or fastener devices to the workpieces.

However, the tool retaining members includes a large volume having a complicated structure or mechanism that may not be easily manufactured and assembled by the workers, and the bolts or screws or fastener devices may not be easily attached or mounted or secured or driven and rotated onto the workpieces by the users themselves without additional driving tools.

The present invention has arisen to mitigate and/or obviate the afore-described disadvantages of the conventional bolts or screws or fastener devices.

### SUMMARY OF THE INVENTION

The primary objective of the present invention is to provide a fastener device including a structure or mechanism to be easily and quickly and readily driven and rotated or mounted or engaged onto the workpiece by the users themselves without additional rotating or driving or actuating tools.

In accordance with one aspect of the invention, there is provided a fastener device comprising a fastener member including a threaded shank, and including a head formed and provided on the threaded shank, and an actuating member including a stem, a screw hole formed in the stem for engaging with the threaded shank of the fastener member, and including a chamber formed therein and communicative with the screw hole for receiving and engaging with the head of the shank, and for allowing the fastener member to be selectively rotated and driven by the actuating member, and for allowing the actuating member to be selectively rotated relative to the fastener member.

The actuating member includes a housing provided on the stem, and the chamber is formed in the housing. The chamber of the housing includes an inner diameter greater than that of the screw hole of the actuating member. The housing includes a serrated outer peripheral surface.

The actuating member includes a peripheral flange extended radially and outwardly from the stem and having an outer diameter greater than that of the stem for forming and defining a peripheral groove in the actuating member. The stem of the actuating member includes a protrusion extended downwardly from a bottom portion of the peripheral flange.

A first workpiece may further be provided and includes a screw hole formed therein for threading and engaging with the threaded shank of the fastener member, and a second workpiece includes an opening formed therein for receiving the fastener member. The stem of the actuating member includes a protrusion for engaging with the opening of the second workpiece.

A sealing ring may further be provided and engaged onto the shank for selectively engaging with the head of the shank of the fastener member. The actuating member includes a housing provided on the stem, and the chamber is formed in the housing for receiving and engaging with the head of the shank.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a fastener device in accordance with the present invention;

FIG. 2 is a perspective view of the fastener device;

FIG. 3 is a cross sectional view of the fastener device taken along lines 3-3 of FIG. 2;

FIG. 4 is a cross sectional view of the fastener device taken along lines 4-4 of FIG. 3;

FIG. 5 is a cross sectional view of the fastener device taken along lines 5-5 of FIG. 1;

FIG. 6 is a cross sectional view illustrating the operation of the fastener device; and

FIGS. 7, 8, 9, 10 are cross sectional views similar to FIG. 6, illustrating the operation of the fastener device.

### DETAILED DESCRIPTION OF THE PREFERRED EMBODIMENT

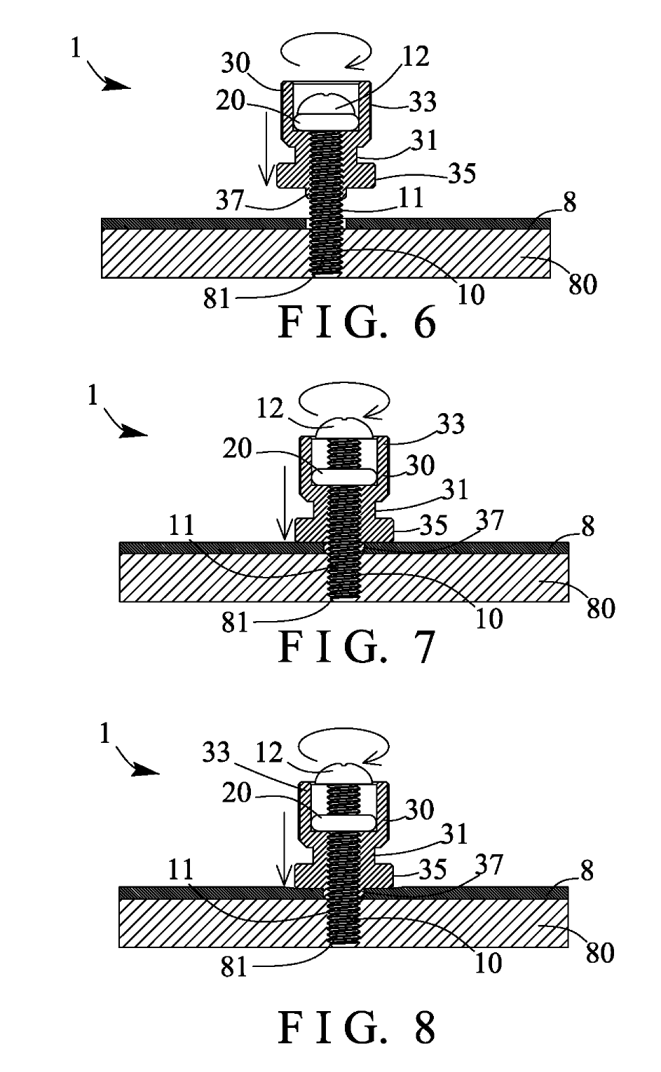

Referring to the drawings, and initially to FIGS. 6-10, a fastener device 1 in accordance with the present invention is provided for being attached or mounted or secured or engaged with or onto the workpieces 8, 80, for attaching or mounting or securing or coupling the workpieces 8, 80 together, or for attaching or mounting or securing or coupling the workpieces 8, 80 to the other supporting members (not shown). For example, the workpiece 80 includes a threaded or screw hole 81 formed therein for receiving or engaging with a threaded bolt or screw or fastener member 10, and the other workpiece 8 includes an opening 82 formed therein and having an inner diameter equal to or greater or no less than that of the screw hole 81 of the workpiece 80 and for slidably receiving or engaging with the fastener member 10.

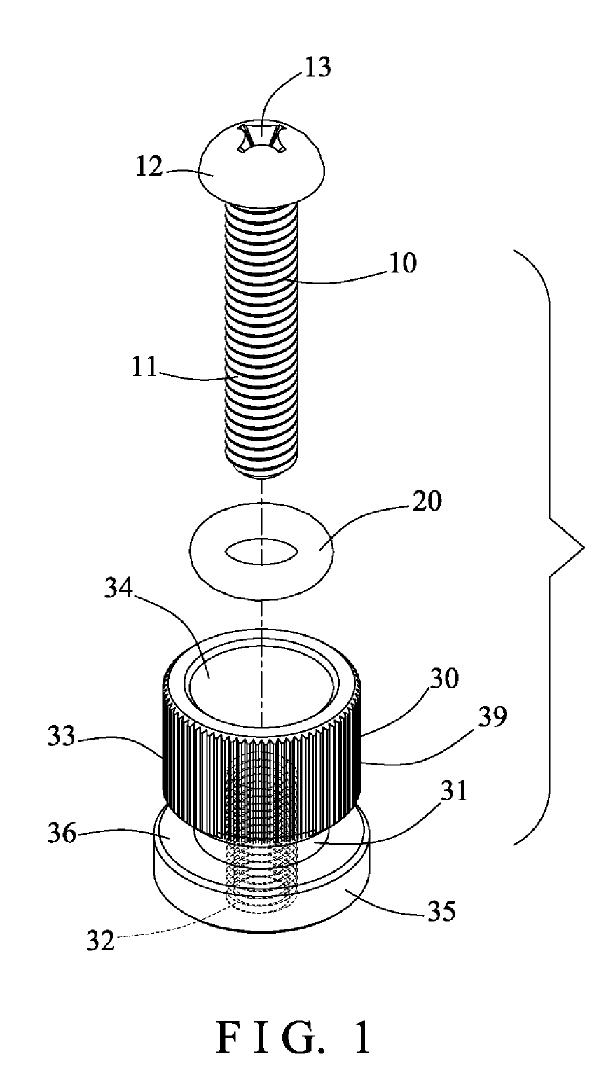

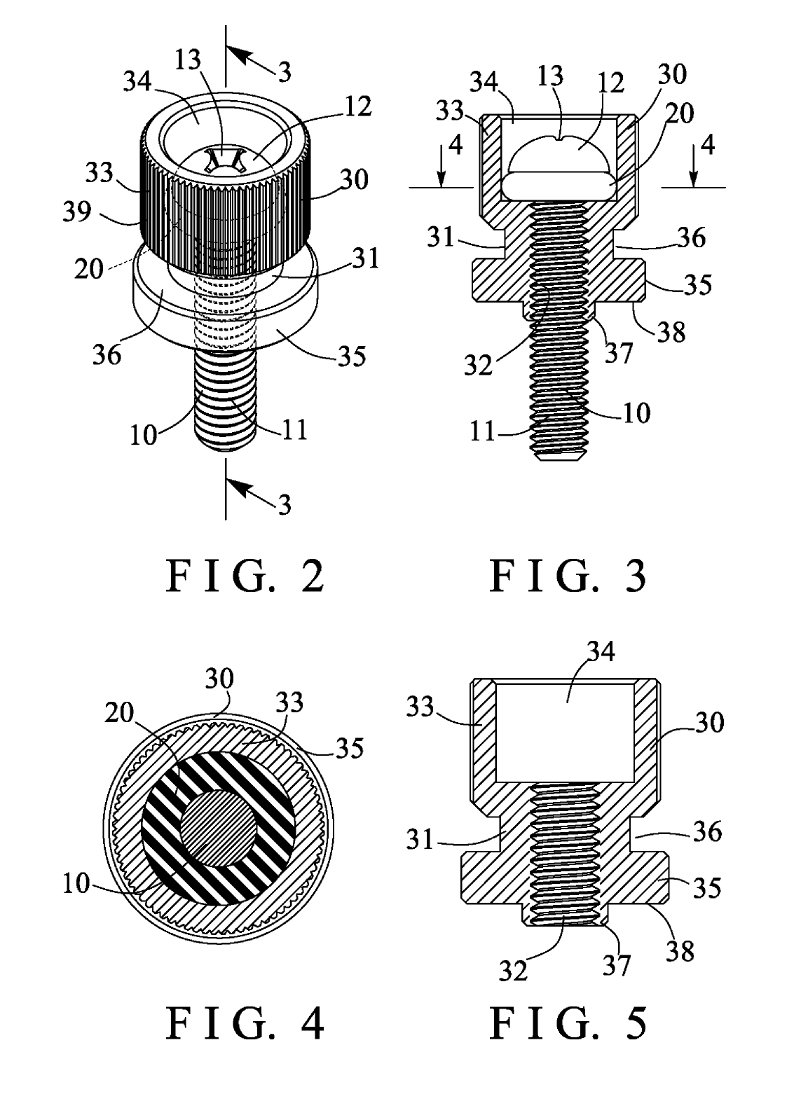

As shown in FIGS. 1-6, the fastener member 10 of the fastener device 1 includes a threaded shank 11 for threading or engaging with the screw hole 81 of the workpiece 80, and includes an enlarged head 12 formed or provided on top of the threaded shank 11 and having an outer diameter greater than that of the shank 11, and includes an engaging hole 13 formed in the head 12 for being engaged with the rotating or driving or actuating tools (not shown) and for allowing the fastener member 10 to be selectively actuated or rotated or driven by the rotating or driving or actuating tools, when required. A gasket or sealing ring 20 may further be provided and attached or mounted or engaged onto the shank 11, and/or contacted or engaged with the head 12 of the shank 11 or of the fastener member 10.

The fastener device 1 further comprises a control ferrule or actuating member 30 including a primary or longitudinal stem 31, an inner thread or threaded screw hole 32 formed in the stem 31 for threading or engaging with the threaded shank 11 of the fastener member 10, a head or casing or housing 33 formed or provided on top of the stem 31 and having an inner space or chamber 34 formed therein, or formed in the stem 31 or in the actuating member 30 and communicative with the inner thread or threaded screw hole 32 and having an inner diameter greater than that of the inner thread or threaded screw hole 32 for receiving or engaging with the head 12 of the shank 11 and/or the sealing ring 20 (FIGS. 3, 4), and a peripheral rib or flange 35 extended radially and outwardly from the outer peripheral portion of the stem 31 and having an outer diameter greater than that of the stem 31 for forming or defining a peripheral space or recess or groove 36 between the peripheral flange 35 and the housing 33, and the stem 31 includes a lower portion or protrusion 37 extended downwardly from or beyond the lower or bottom portion 38 of the peripheral flange 35. The housing 33 includes a serrated or rough or coarse outer peripheral surface 39 for allowing the housing 33 of the actuating member 30 to be effectively or forcefully actuated or rotated or driven by the user.

In operation, as shown in FIG. 6, when the head 12 of the shank 11 of the fastener member 10 and/or the sealing ring 20 is contacted or engaged with the housing 33 and/or the stem 31, the shank 11 of the fastener member 10 is arranged to be actuated or rotated or driven clockwise relative to the workpieces 8, 80 with or by the housing 33 of the actuating member 30 and may be caused or forced to thread or engage with the screw hole 81 of the workpiece 80 and for allowing the shank 11 of the fastener member 10 to be attached or mounted or secured to the workpieces 8, 80. As shown in FIG. 7, when the fastener member 10 is attached or mounted or secured to the workpieces 8, 80 and may no longer be actuated or rotated or driven relative to the workpieces 8, 80 with or by the housing 33 of the actuating member 30, the housing 33 of the actuating member 30 may be pivoted or rotated clockwise relative to the fastener member 10 until the peripheral flange 35 of the actuating member 30 is contacted or engaged with the workpiece 8.

As shown in FIG. 8, when the housing 33 of the actuating member 30 is further pivoted or rotated clockwise relative to the fastener member 10 to engage the protrusion 37 of the stem 31 into the opening 82 of the other workpiece 80, and/or to contact or to engage the bottom portion 38 of the peripheral flange 35 with the workpiece 8, the fastener member 10 may be solidly and stably attached or mounted or secured and locked to the workpieces 8, 80 with only the actuating member 30, without additional rotating or driving or actuating tools. The fastener member 10 may be effectively or forcefully actuated or rotated or driven relative to the workpieces 8, 80 with the actuating member 30, and/or the actuating member 30 may be effectively or forcefully actuated or rotated or driven relative to the fastener member 10 by the user with the serrated or rough or coarse outer peripheral surface 39 of the housing 33.

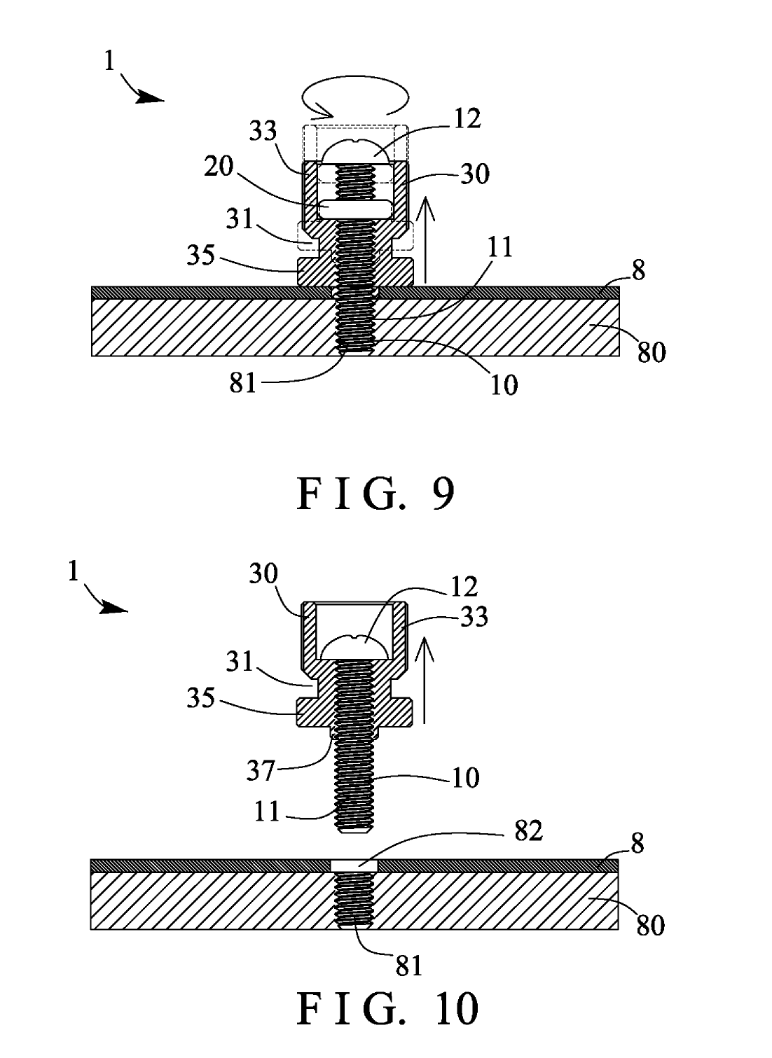

As shown in FIG. 9, when it is required to unthread or remove or disengage or release the fastener member 10 from the workpieces 8, 80, the housing 33 of the actuating member 30 may be pivoted or rotated counterclockwise relative to the fastener member 10 and the workpieces 8, 80, and the housing 33 of the actuating member 30 may be pivoted or rotated and moved relative to the fastener member 10 until the housing 33 and/or the stem 31 of the actuating member 30 is contacted or engaged with the head 12 of the shank 11 of the fastener member 10 (FIG. 10) and/or the sealing ring 20, and the fastener member 10 may then be actuated or rotated or driven relative to the workpieces 8, 80 with the actuating member 30 until the fastener member 10 is removed or disengaged or released from the workpieces 8, 80.

The sealing ring 20 is provided for making an air tight or water tight seal between the fastener member 10 and the actuating member 30. However, without the sealing ring 20, the fastener member 10 may also be actuated or rotated or driven relative to the workpieces 8, 80 with the actuating member 30, and the actuating member 30 may also be actuated or rotated or driven relative to the fastener member 10. Without the sealing ring 20, the head 12 of the shank 11 of the fastener member 10 may also be directly contacted or engaged with the housing 33 and/or the stem 31, and the shank 11 of the fastener member 10 may also be actuated or rotated or driven clockwise relative to the workpieces 8, 80 with or by the housing 33 of the actuating member 30 and may be caused or forced to thread or engage with the screw hole 81 of the workpiece 80.

Accordingly, the fastener device in accordance with the present invention includes a structure or mechanism to be easily and quickly and readily driven and rotated or mounted or engaged or secured onto the workpiece by the users themselves without additional rotating or driving or actuating tools.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener device comprising:
a fastener member including a threaded shank, and including a head formed and provided on said threaded shank, and
an actuating member including a stem, a screw hole formed in said stem for engaging with said threaded shank of said fastener member, and including a chamber formed therein and
communicative with said screw hole for receiving and engaging with said head of said shank, and for allowing said fastener member to be selectively rotated and driven by said actuating member, and for allowing said actuating member to be selectively rotated relative to said fastener member.

2. The fastener device as claimed in claim 1, wherein said actuating member includes a housing provided on said stem, and said chamber is formed in said housing.

3. The fastener device as claimed in claim 2, wherein said chamber of said housing includes an inner diameter greater than that of said screw hole of said actuating member.

4. The fastener device as claimed in claim 2, wherein said housing includes a serrated outer peripheral surface.

5. The fastener device as claimed in claim 1, wherein said actuating member includes a peripheral flange extended radially and outwardly from said stem and having an outer diameter greater than that of said stem for forming and defining a peripheral groove in said actuating member.

6. The fastener device as claimed in claim 5, wherein said stem of said actuating member includes a protrusion extended downwardly from a bottom portion of said peripheral flange.

7. The fastener device as claimed in claim 1 further comprising a first workpiece including a screw hole formed therein for threading and engaging with said threaded shank of said fastener member, and a second workpiece including an opening formed therein for receiving said fastener member.

8. The fastener device as claimed in claim 7, wherein said stem of said actuating member includes a protrusion for engaging with said opening of said second workpiece.

9. The fastener device as claimed in claim 1 further comprising a sealing ring engaged onto said shank for selectively engaging with said head of said shank of said fastener member.

10. The fastener device as claimed in claim 9, wherein said actuating member includes a housing provided on said stem, and said chamber is formed in said housing for receiving and engaging with said head of said shank.
